(19) United States
(12) Patent Application Publication
(10) Pub. No.: US 2010/0200095 A1
(43) Pub. Date: Aug. 12, 2010

(54) HERMETIC COMPRESSOR

(75) Inventors: Kazuhiro Yokota, Kanagawa (JP); Kiwamu Watanabe, Kanagawa (JP)

Correspondence Address: RATNERPRESTIA, P.O. BOX 980, VALLEY FORGE, PA, 19482, US

(73) Assignee: MATSUSHITA ELECTRIC INDUSTRIAL CO., LTD., Osaka (JP)

(21) Appl. No.: 11/917,946

(22) PCT Filed: Apr. 13, 2007
(86) PCT No.: PCT/JP2007/058569

§ 371 Date: Dec. 18, 2007

(30) Foreign Application Priority Data
Apr. 19, 2006 (JP) 2006-115206

(51) Int. Cl. F16K 15/16; E03B 5/00

(52) U.S. Cl. 137/857; 137/565.11

(57) ABSTRACT

The inclination of the suction reed at the time of sucking the refrigerant can be increased when L/S is not more than 0.25 where S (mm²) represents the area within the periphery of the suction valve seat of the suction reed, and L (mm) represents the length between the support end and the tip on the opening/closing part side of the suction reed. The increased inclination of the suction reed smoothes the flow of the refrigerant into the cylinder bore from the inside of the suction valve seat so as to reduce the suction resistance and the clearance volume, thereby reducing the re-expansion loss. As a result, the refrigerant flow is increased to increase the volumetric efficiency, thereby improving the freezing performance of the hermetic compressor.

This application is a U.S. National Phase Application of PCT International Application PCT/JP2007/058569.

### TECHNICAL FIELD

The present invention relates to hermetic compressors used in refrigerators.

### BACKGROUND ART

Some conventional hermetic compressors for high efficiency have a plurality of suction ports in order to reduce the entire suction resistance as disclosed, for example, in Japanese Patent Unexamined Publication No. H09-072280.

The conventional hermetic compressor is described as follows with reference to drawings. FIG. 8 is a sectional view of the hermetic compressor of the aforementioned Patent Document 1. FIG. 9 is a schematic diagram of a valve plate of the hermetic compressor. FIG. 10 is a schematic diagram of a suction reed of the hermetic compressor.

As shown in FIG. 8, the hermetic compressor includes block 401 having cylinder bore 402 in which piston 403 reciprocates. Cylinder bore 402 has valve plate 404 at an opening end thereof so as to seal it. Between valve plate 404 and the opening end of cylinder bore 402 is sandwiched suction reed 405.

As shown in FIG. 9, valve plate 404 has two suction ports 406 perforated therein, and suction ports 406 have suction valve seats 407 at the periphery thereof on the cylinder bore 402 side. As shown in FIG. 10, suction reed 405 includes opening/closing part 408 opening and closing suction valve seats 407, support end 409 functioning as the base of suction reed 405, and arm 410 connecting support end 409 and opening/closing part 408. Support end 409 indicates the boundary between the portion that moves to function substantially as the reed and the portion that does not move when suction reed 405 is displaced. Support end 409 corresponds to an area “A” enclosed by the dotted line shown in FIG. 10.

The compressor having the aforementioned structure operates as follows. When piston 403 reciprocates in cylinder bore 402, the pressure in cylinder bore 402 is reduced during the suction stroke, thereby producing a pressure difference between suction ports 406 and cylinder bore 402. When suction reed 405 is opened into cylinder bore 402 in such a manner that arm 410 is bent about support end 409, refrigerant is sucked into cylinder bore 402 through suction ports 406 via suction valve seats 407. During the discharge stroke, on the other hand, the pressure in cylinder bore 402 is increased to close suction reed 405 so as to block suction valve seats 407. As a result, the refrigerant is discharged from cylinder bore 402.

As understood from the above-described operation, suction ports 406 and suction valve seats 407 form paths to guide the refrigerant into cylinder bore 402. Providing the plurality of suction ports 406 and the plurality of suction valve seats 407 increases the passage section of the refrigerant so as to reduce suction resistance.

However, in the aforementioned conventional structure, the plurality of suction valve seats block and disturb the flow of the refrigerant sucked from inside the suction valve seats into the cylinder bore. As a result, the opening/closing part increases the suction resistance, making it impossible to suck a sufficient amount of refrigerant.

In the conventional suction reed, the reed portion is formed by cutting the sheet material along the periphery of the reed portion. The cut-out portion results in a clearance volume. The clearance volume means a space formed in the upper part of the piston on the valve-plate side when the piston reaches top dead center. In the aforementioned structure, providing the plurality of suction valve seats causes an increase in the peripheral length of the suction reed, thereby increasing the clearance volume when the suction reed is shaped to block suction valve seats. The increased clearance volume increases re-expansion loss, which causes a decrease in volumetric efficiency and hence in refrigerant flow. As a result, the hermetic compressor does not have sufficient efficiency.

### SUMMARY OF THE INVENTION

The hermetic compressor of the present invention includes a block having a cylinder bore and using R600a as a refrigerant, a piston reciprocating in the cylinder bore, and a valve plate disposed to seal the opening end of the cylinder bore of the block. The hermetic compressor further includes a sucking valve having a suction port perforated in the valve plate, a suction valve seat formed at the periphery on the cylinder bore side of the suction port, and a cantilever suction reed opening and closing the suction valve seat. The suction reed is formed of a leaf spring and includes an opening/closing part opening and closing the suction valve seat, a support end functioning as the base of the suction reed, and an arm connecting the opening/closing part and the support end. L/S is not more than 0.25 where L (mm) represents the length between the support end and the tip on the opening/closing part side of the suction reed, and S (mm²) represents the area within the periphery of the suction valve seat of the suction reed.

This structure allows the suction reed to have a shorter periphery to reduce the clearance volume. This structure also facilitates the flow of the refrigerant along the suction reed by increasing the inclination of the suction reed during the sucking of the refrigerant. The increased inclination of the suction reed is achieved by the large area of the opening/closing part, which is affected by the pressure difference that is the driving force to open the suction reed and by the small length L. Consequently, the flow of the refrigerant into the cylinder bore is smoothed to reduce the re-expansion loss and the suction resistance, thereby increasing the refrigerant flow and hence the volumetric efficiency. As a result, the hermetic compressor has high efficiency.

### BRIEF DESCRIPTION OF THE DRAWINGS

FIG. 1 is a sectional view of a hermetic compressor according to an embodiment of the present invention.

FIG. 2 is a schematic diagram of a valve plate of the hermetic compressor according to the embodiment of the present invention.

FIG. 3 is a schematic diagram of a suction reed of the hermetic compressor according to the embodiment of the present invention.

FIG. 4 is a side schematic diagram of the suction reed of the hermetic compressor according to the embodiment of the present invention.

FIG. 5 is a graph showing measurement results of volumetric efficiency and the ratio of the length between the support end and the tip on the opening/closing part side of the suction reed to the area within the periphery of a suction valve seat of the suction reed of the hermetic compressor according to the embodiment of the present invention.

FIG. 6 is a graph showing measurement results of the volumetric efficiency and the area within the periphery of the suction valve seat of the suction reed of the hermetic compressor according to the embodiment of the present invention.

FIG. 7 is a graph showing measurement results of the volumetric efficiency and the length between the support end and the tip on the opening/closing part side of the suction reed of the hermetic compressor according to the embodiment of the present invention.

FIG. 8 is a cross sectional view of a conventional hermetic compressor.

FIG. 9 is a schematic diagram of a valve plate of the conventional hermetic compressor.

FIG. 10 is a schematic diagram of a suction reed of the conventional hermetic compressor.

### DETAILED DESCRIPTION OF PREFERRED EMBODIMENTS

Embodiments of the present invention are described as follows with reference to drawings. Note that the present invention is not limited to these embodiments.

### Embodiment

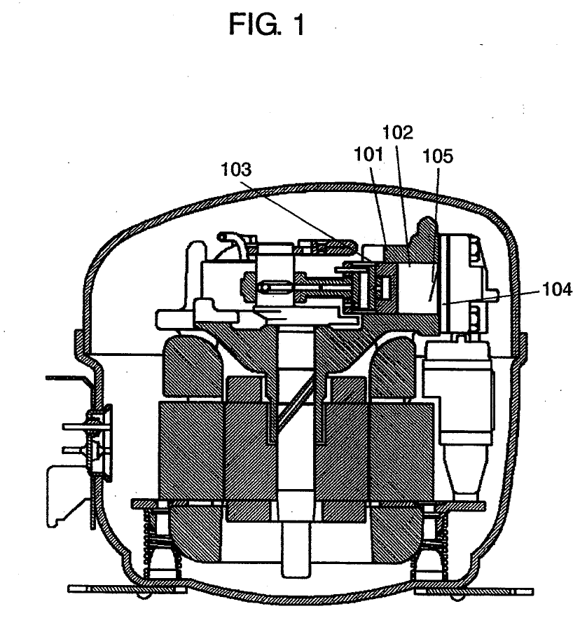

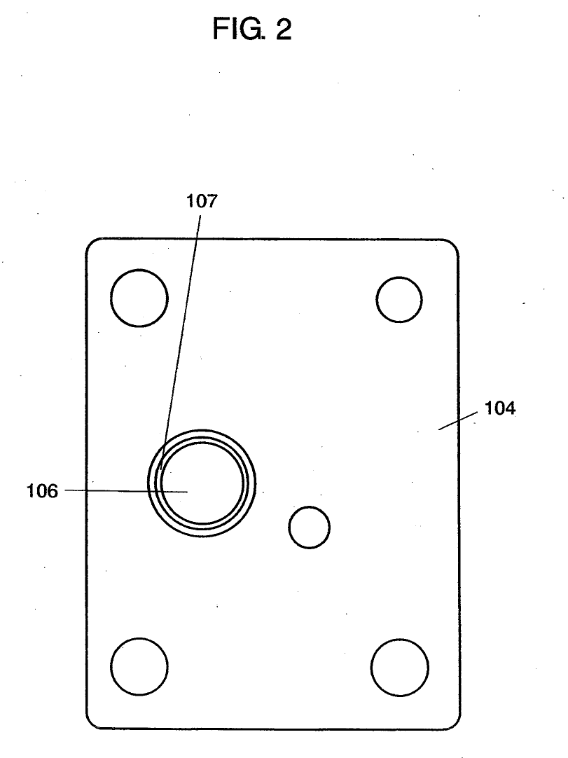

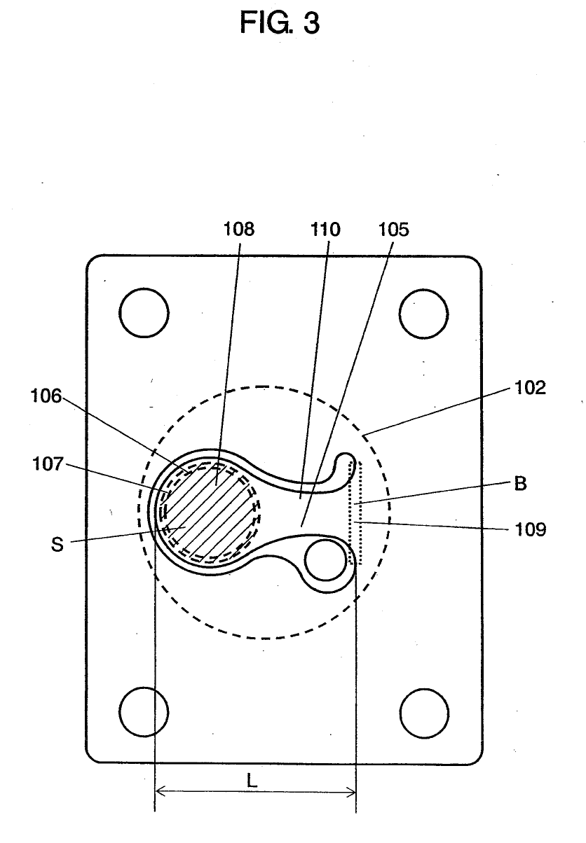

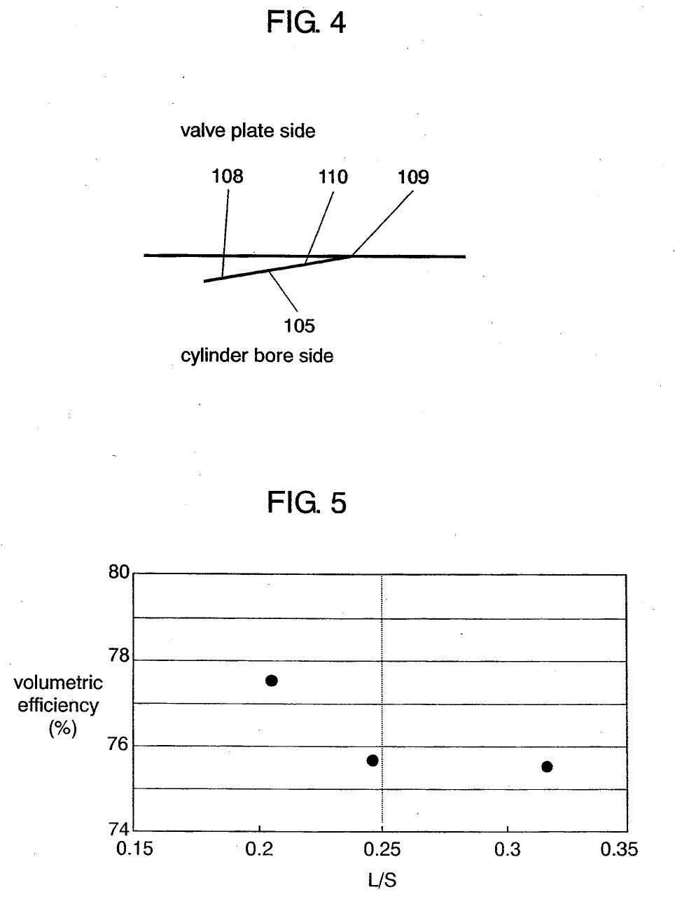

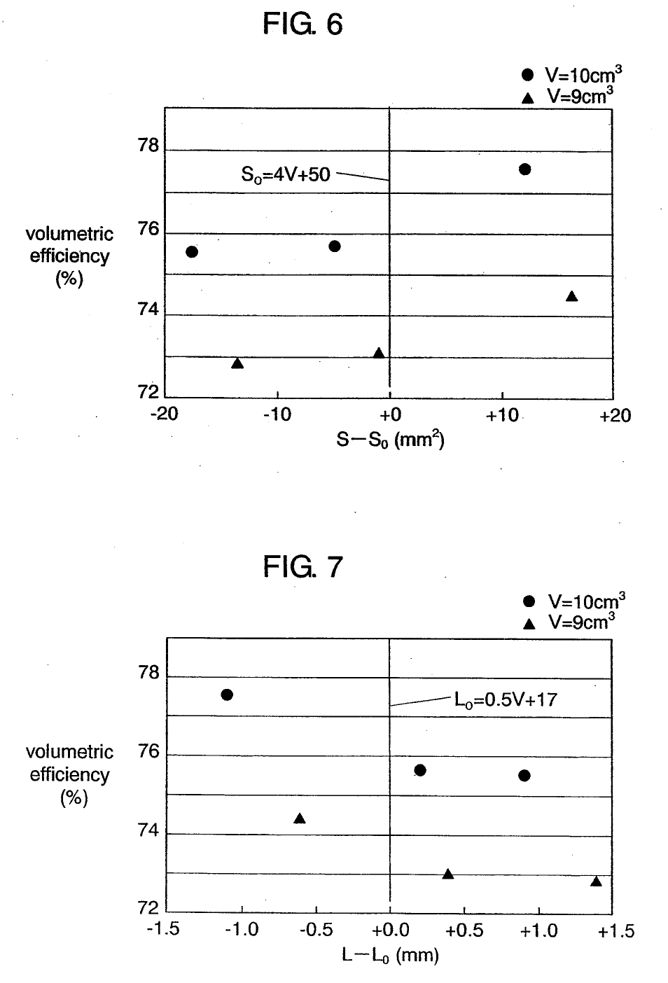

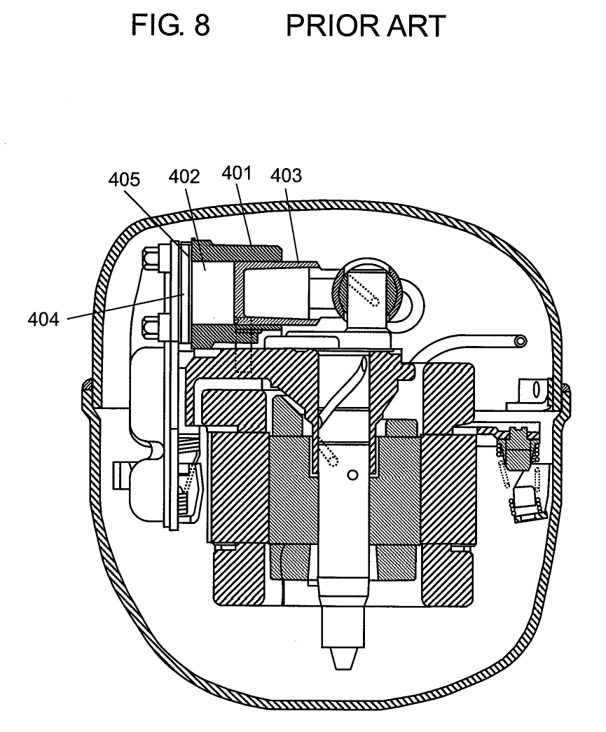

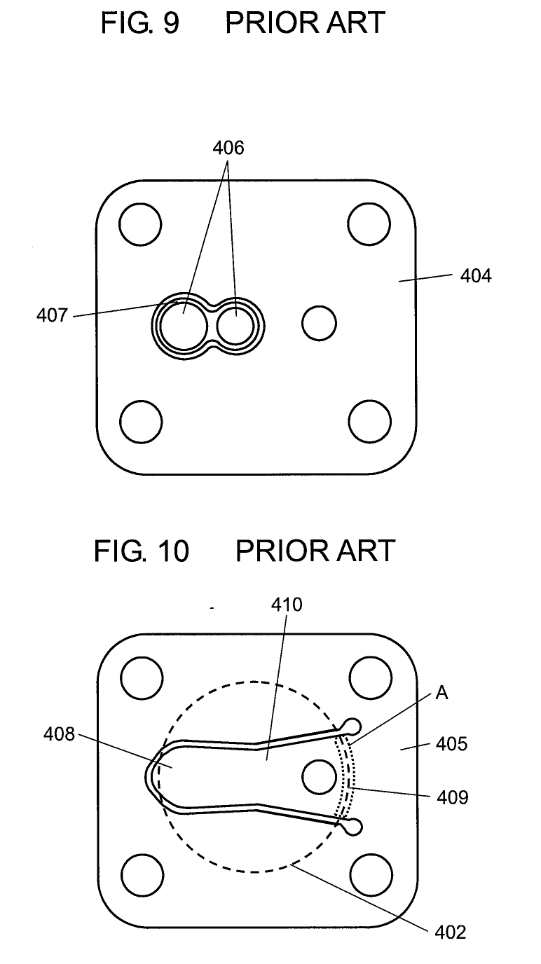

FIG. 1 is a sectional view of a hermetic compressor according to an embodiment of the present invention. FIG. 2 is a schematic diagram of a valve plate of the hermetic compressor. FIG. 3 is a schematic diagram of a suction reed of the hermetic compressor. FIG. 4 is a side schematic diagram of the suction reed. FIG. 5 is a graph showing measurement results of volumetric efficiency and the ratio of the length between the support end and the tip on the opening/closing part side of the suction reed to the area within the periphery of a suction valve seat of the suction reed. FIG. 6 is a graph showing measurement results of the volumetric efficiency and the area within the periphery of the suction valve seat of the suction reed. FIG. 7 is a graph showing measurement results of the volumetric efficiency and the length between the support end and the tip on the opening/closing part side of the suction reed of the hermetic compressor.

As shown in FIG. 1, the hermetic compressor includes block 101 having cylinder bore 102 in which piston 103 reciprocates. Cylinder bore 102 has valve plate 104 at an opening end thereof so as to seal it. Between valve plate 104 and the opening end of cylinder bore 102 is sandwiched suction reed 105.

As shown in FIG. 2, valve plate 104 has suction port 106 perforated therein, and suction port 106 has suction valve seat 107 at the periphery thereof on the cylinder bore 102 side. Suction valve seat 107 is opened and closed by cantilever suction reed 105.

As shown in FIG. 3, suction reed 105 is formed of a leaf spring, and includes opening/closing part 108 opening and closing suction valve seat 107, support end 109 functioning as the base of suction reed 105, and arm 110 connecting opening/closing part 108 and support end 109. Suction reed 105 is bent in the vicinity of support end 109 toward cylinder bore 102. Thus, a sucking valve includes suction port 106, suction valve seat 107, and cantilever suction reed 105 for opening and closing suction valve seat 107.

Support end 109 indicates the boundary between the portion that moves to function substantially as the reed and the portion that does not move when suction reed 105 is displaced. In the present first embodiment, support end 109 corresponds to the portion where suction reed 105 increases in width and rigidity, that is, an area “B” enclosed by the dotted line shown in FIG. 3.

Support end 109 is located within the extension of the inner diameter of cylinder bore 102.

The length L between support end 109 and the tip on the opening/closing part 108 side of suction reed 105 is set to 20 mm. The area S within the periphery of suction valve seat 107 of suction reed 105 is set to 100 mm². The cylinder capacity V, which is determined by the reciprocating distance of piston 103 and the inner diameter of cylinder bore 102, is set to 10 cm³. As the refrigerant, R600a is used.

The following is a description of the operation and action of the compressor thus structured. When piston 103 reciprocates in cylinder bore 102, the pressure in cylinder bore 102 is reduced during the suction stroke. This produces a pressure difference between inside suction valve seat 107 and inside cylinder bore 102 so as to apply a force to opening/closing part 108 of suction reed 105, which blocks suction valve seat 107. As a result, as shown in FIG. 4, when suction reed 105 is opened into cylinder bore 102 in such a manner that arm 110 is bent about support end 109, refrigerant is sucked into cylinder bore 102 through suction port 106 via the inside of suction valve seat 107.

At this moment, in the present embodiment, suction valve seat 107 has a large inside area to allow suction reed 105 to be opened when the pressure difference between inside suction valve seat 107 and inside cylinder bore 102 is still small, that is, when piston 103 has moved a little from top dead center toward bottom dead center.

This increases the refrigerant flow. Furthermore, suction valve seat 107 and suction port 106 are large in size to allow a reduction in the suction resistance of the refrigerant passing through them. This improves the freezing performance of the hermetic compressor.

In addition, in the present embodiment, suction reed 105 is bent in the vicinity of support end 109 toward cylinder bore 102. When thus bent in the vicinity of support end 109 toward cylinder bore 102, suction reed 105, which is formed of a leaf spring, generates a force to displace itself toward cylinder bore 102 while blocking suction valve seat 107. In other words, suction reed 105 is subjected to the force to displace it toward cylinder bore 102 in addition to the pressure difference between inside suction valve seat 107 and inside cylinder bore 102. This allows suction reed 105 to be opened at an earlier timing so as to increase its displacement, thereby increasing the volumetric efficiency.

Generally, there is a concern that an increase in the size of suction valve seat 107 increases the pressure inside cylinder bore 102 during the compression stroke and that the pressure difference between inside suction valve seat 107 and inside cylinder bore 102 applies a large force to opening/closing part 108 of suction reed 105, thereby damaging suction reed 105. In the present embodiment, however, R600a used as the refrigerant is lower in pressure and density than R134a at the same evaporation temperature. Since R600a less affects on suction reed 105 than R134a, suction valve seat 107 is allowed to have larger inner and outer diameters than in the case of using R134a.

Next, the length between support end 109 and the tip on the opening/closing part 108 side of suction reed 105 is L (mm), and the area S within the periphery of suction valve seat 107 of suction reed 105 is set to S (mm²). The relationship between the length L and the area S has been studied and it has been found that there is a point at which the volumetric efficiency suddenly increases.

The inner area of suction valve seat 107 or the diameter of suction port 106 is determined in terms of the suction resistance. The width of suction valve seat 107 is set in the range of 0.3 to 1.5 mm. This value is based on the interrelation between the viscosity resistance of the refrigerating machine oil at the time of opening suction reed 105 and on the air tightness of opening/closing part 108. These values determine the area S within the periphery of suction valve seat 107 of suction reed 105.

The area S within the periphery of suction valve seat 107 of suction reed 105 is adopted as an important parameter for a design study by considering the suction resistance of the refrigerant passing through the inside of suction valve seat 107 and the resistance caused when opening/closing part 108 of suction reed 105 blocks the flow of the refrigerant sucked into cylinder bore 102.

Opening/closing part 108 is generally larger by 0.2 to 1.0 mm than the periphery of suction valve seat 107 in order to prevent suction reed 105 from being damaged by the end portion of opening/closing part 108 of suction reed 105 hitting against suction valve seat 107.

FIG. 5 shows the measurement results of the ratio of L to S (L/S) and the volumetric efficiency. As seen from FIG. 5, the volumetric efficiency increases suddenly when the L/S reaches 0.25 or below.

The reason for this sudden increase seems to be as follows.

If suction valve seat 107, the inner area of suction valve seat 107, and suction port 106 are increased in size, it is necessary to increase opening/closing part 108 of suction reed 105. This makes it impossible to suck a sufficient amount of refrigerant into cylinder bore 102 because the enlarged opening/closing part 108 blocks the flow of the refrigerant sucked from inside suction valve seat 107 into cylinder bore 102.

In the present first embodiment, however, setting the L/S to not more than 0.25 makes the relative length of arm 110 small with respect to the area within the periphery of suction valve seat 107 of suction reed 105. Consequently, when the tip on the opening/closing part 108 side of suction reed 105 is displaced the same amount as in the case where arm 110 is longer, the straight line connecting the tip on the opening/closing part 108 side of suction reed 105 and support end 109 form a larger angle with valve plate 104, thereby increasing the inclination of suction reed 105. This seems to allow the refrigerant to smoothly flow into cylinder bore 102 along suction reed 105.

The reduced relative length between support end 109 and the tip on the opening/closing part 108 side of suction reed 105 reduces the peripheral length of suction reed 105 and hence the clearance volume. This reduces the re-expansion loss so as to increase the volumetric efficiency.

In the L/S ratio (L/S), the area S within the periphery of suction valve seat 107 of suction reed 105 is small with respect to the inner diameter of cylinder bore 102 and cannot be greater than a certain value in accordance with the cylinder capacity V of the compressor.

In the case where the length L between support end 109 and the tip on the opening/closing part 108 side of suction reed 105 is too small, arm 110 or support end 109 may be subjected to a large stress and highly likely to be damaged when suction reed 105 is displaced during the suction stroke. To avoid this, the length L is required to be not less than a certain value in accordance with the use conditions of the compressor.

Consequently, although the design conditions are limited from the aforementioned viewpoint, as shown in FIG. 5, the volumetric efficiency is surely increased when the ratio of L to S (L/S) is approximately 0.2 or below.

Next, the relationship between the area S (mm²) and the cylinder capacity V (cm³) has been studied and it has been found that there is a point at which the volumetric efficiency suddenly increases. The area S is enclosed within the periphery of suction valve seat 107 of suction reed 105, and the cylinder capacity V is an indicator of the refrigerant flow passing through the inside of suction valve seat 107. FIG. 6 shows the measurement results of the relationship between the volumetric efficiency and the area S within the periphery of suction valve seat 107. In FIG. 6, the horizontal axis represents S−S₀ where S₀ is a constant to normalize the horizontal axis. The constant S₀ is determined to satisfy the relation S₀=4V+50 using the cylinder capacity V (cm³).

The volumetric efficiency is obtained when the cylinder capacity V is 9 cm³ and 10 cm³.

From these results, it has been found that the volumetric efficiency suddenly increases when S is larger than S₀ that satisfies the relation S₀=4V+50, that is, when S reaches the value that satisfies the relation S>4V+50. The reason for this seems to be that when the relation S>4V+50 is satisfied, the suction resistance of the refrigerant flowing into cylinder bore 102 from the inside of suction valve seat 107 can be low enough to make the refrigerant flow commensurate with the cylinder capacity.

In S−S₀, the area S within the periphery of suction valve seat 107 of suction reed 105 is small with respect to the inner diameter of cylinder bore 102 and cannot be greater than the certain value in accordance with the cylinder capacity V of the compressor.

Consequently, although the design conditions are limited from the aforementioned viewpoint, as shown in FIG. 6, the volumetric efficiency is surely increased when the value of S−S₀ is approximately 17 or lower.

The relationship between the length L (mm) between support end 109 and the tip on the opening/closing part 108 side of suction reed 105 and the cylinder capacity V (cm³) has been studied and it has been found that there is a point at which the volumetric efficiency suddenly increases. FIG. 7 shows the measurement results of the relationship between the length L and the cylinder capacity V. In FIG. 7, the horizontal axis represents L−L₀ where L₀ is a constant to normalize the horizontal axis. The constant L₀ is determined to satisfy the relation L₀=0.5V+17 using the cylinder capacity V (cm³). The volumetric efficiency is obtained when the cylinder capacity V is 9 cm³ and 10 cm³.

As seen from FIG. 7, the volumetric efficiency remarkably increases when L is smaller than L₀ that satisfies the relation L₀=0.5V+17, that is, when L satisfies the relation L<0.5V+17.

The reason for this seems to be as follows. Increasing the cylinder capacity generally accelerates the rate at which the pressure in cylinder bore 102 reduces during the suction stroke, thereby accelerating the rate at which the refrigerant is sucked into cylinder bore 102. Therefore, if the length between support end 109 and the tip on the opening/closing part 108 side of suction reed 105 is too large, the tip on the opening/closing part 108 side of suction reed 105 collides with the valve plate 104 side of piston 103 and bounces back. This reduces the displacement of suction reed 105.

It also seems that when the displacement of suction reed 105 is insufficient, the flow of the refrigerant into cylinder bore 102 is blocked, which causes an increase in the suction resistance and hence a decrease in the volumetric efficiency.

Furthermore, when the tip on the opening/closing part 108 side of suction reed 105 collides with the valve plate 104 side of piston 103, the impact may damage suction reed 105. Making L satisfy the relation L<0.5V+17 ensures the necessary amount of displacement of suction reed 105 so as to prevent the tip on the opening/closing part 108 side of suction reed 105 from colliding with the valve plate 104 side of piston 103. This provides the compressor with higher reliability in addition to the increased volumetric efficiency.

On the other hand, the value of L can be minimized to reduce the clearance volume of the peripheral length of suction reed 105, thereby reducing the re-expansion loss.

In the relation L<0.5V+17, when the length L between support end 109 and the tip on the opening/closing part 108 side of suction reed 105 is too small, arm 110 or support end 109 may be subjected to a large stress and highly likely to be damaged when suction reed 105 is displaced during the suction stroke. To avoid this, the length L is required to be not less than a certain value in accordance with the use conditions of the compressor.

Consequently, although the design conditions are limited from the aforementioned viewpoint, as shown in FIG. 7, the volumetric efficiency is surely increased when the value of the relation L−L₀ is approximately −1.2 or below.

In the case where support end 109 of suction reed 105 is disposed outside the inner diameter of cylinder bore 102, support end 109 is supported by a component other than suction reed 105. This makes support end 109 more likely to be subjected to changes in position, angle, or the like due to the positional variations during the assembly of the compressor, thereby causing variations in the movement of suction reed 105. This makes the freezing performance unstable and requires suction reed 105 to have a larger peripheral length.

As described above, if support end 109 of suction reed 105 is disposed outside the inner diameter of cylinder bore 102, the freezing performance varies due to the unstable movement of suction reed 105, and the peripheral length of suction reed 105 is increased. As a result, the clearance volume is increased, causing an increase in the re-expansion loss and hence a decrease in the volumetric efficiency.

In the present embodiment, however, support end 109 is located within the extension of the inner diameter of cylinder bore 102. This structure makes support end 109 less likely to be subjected to changes in position, angle, or the like and stabilizes the movement of suction reed 105. The reduced clearance volume leads to a reduction in the re-expansion loss so as to increase the volumetric efficiency and to stabilize the freezing performance. As a result, the hermetic compressor has high efficiency.

### INDUSTRIAL APPLICABILITY

As described hereinbefore, the hermetic compressor of the present invention, which has high efficiency and high reliability, is useful for air conditioners, refrigerators-freezers, and the like.

1. A hermetic compressor comprising:
a block having a cylinder bore and using R600a as a refrigerant;
a piston reciprocating in the cylinder bore;
a valve plate disposed to seal an opening end of the cylinder bore of the block; and
a sucking valve including:
a suction port perforated in the valve plate;
a suction valve seat formed at a periphery on a side of the cylinder bore of the suction port; and
a cantilever suction reed opening and closing the suction valve seat, the suction reed being formed of a leaf spring and including:
an opening/closing part opening and closing the suction valve seat;
a support end functioning as a base of the suction reed; and
an arm connecting the opening/closing part and the support end, wherein
L/S is not more than 0.25 where L (mm) represents a length between the support end and a tip on a side of the opening/closing part of the suction reed, and S (mm²) represents an area within a periphery of the suction valve seat of the suction reed.

2. The hermetic compressor of claim 1, wherein
a relation L<0.5V+17 is satisfied where L (mm) represents the length between the support end and the tip on the side of the opening/closing part of the suction reed, and V (cm³) represents a cylinder capacity determined by a reciprocating distance of the piston and an inner diameter of the cylinder bore.

3. The hermetic compressor of claim 1, wherein
a relation S>4V+50 is satisfied where S (mm²) represents the area within the periphery of the suction valve seat of the suction reed, and V (cm³) represents a cylinder capacity determined by a reciprocating distance of the piston and an inner diameter of the cylinder bore.

4. The hermetic compressor of one of claim 1, wherein the suction reed is bent in a vicinity of the support end toward the cylinder bore.

5. The hermetic compressor of one of claim 1, wherein the support end is located within an extension of an inner diameter of the cylinder bore.
